(19) United States
(12) Patent Application Publication
(10) Pub. No.: US 2001/0055962 A1
(43) Pub. Date: Dec. 27, 2001

(54) Information distribution system for distributing information by using visual device and electrical device

(76) Inventor: Taneaki Chiba, Tokyo (JP)

Correspondence Address: McGuire Woods, 1750 Tysons Boulevard, Suite 1800, Tysons Corner, McLean, VA, 22102-4215, US

(21) Appl. No.: 09/886,366

(22) Filed: Jun. 22, 2001

(30) Foreign Application Priority Data
Jun. 26, 2000 (JP) 190982/2000

(51) Int. Cl. H04M 11/10

(52) U.S. Cl. 455/412; 455/524; 455/422

(57) ABSTRACT

An information distribution system is composed of a plurality of information distribution units, a server, and a mobile terminal. The server selects at least one of the plurality of information distribution units, and transmits first information to the selected information distribution unit. The selected information distribution unit includes a transmitting unit and a display unit. The transmitting unit electrically transmits to the mobile terminal the first information received from the server such that the mobile terminal is able to display the first information. The display unit visually displays second information.

### BACKGROUND OF THE INVENTION

1. Field of the Invention

The present invention relates to an information distribution system. More particularly, the present invention relates to an information distribution system for distributing an information by an electrical device.

2. Description of the Related Art

Information distributors se various media such as a newspaper, a television, a radio, a magazine and an advertisement signboard. However, it is not always easy that a receiver of the information periodically obtains only the information desired by the receiver from those media.

Computer networks such as the Internet are media from which a user obtains only desirable information. The user obtains the desirable information by getting access to databases on the networks and searching through them. However, the operation for periodically getting access to the networks is annoying.

An information distribution system for distributing an information without an annoying operation is disclosed in Japanese Laid Open Patent Application (JP-A-Heisei, 8-18523). The conventional information distribution system is installed in a doorway of a region into which a ticket is required to enter, as shown in FIG. 1. FIG. 1 shows an example in which the doorway of the region is a ticket barrier, and the ticket is a commutation ticket.

The conventional information distribution system is provided with a reader 103, an information accumulator 104, an information manager 105, a transmission manager 106, a system manager 107, and a radio transmitter 162. The reader 103 and the radio transmitter 162 are installed in the ticket barrier. The information accumulator 104 accumulates information to be provided to users. The information manager 105 manages the information to be provided to the users, and obtains the information to be provided to the users from an external information resource 109 if necessary.

Each of the users defines in advance the content of the information to be provided and received. That is, each of the users concludes a contract to receive the information with a manager of the information distribution system.

The user 101 carries a portable memory 102 and a portable information terminal 108. The portable memory 102 is the medium in which information is magnetically stored, and it is used as the commutation ticket.

When the user inserts the portable memory 102 into the reader 103, the reader 103 reads information stored in the portable memory 102. Then the reader 103 judges whether or not the user is allowed to go into a premise of a station on the basis of the information in the portable memory 102.

Moreover, the user is identified on the basis of the read information. When, the user is identified, the transmission manager 106 transmits the information of the defined content through the radio transmitter 162 to the portable information terminal 108. The user obtains the desirable information only by inserting the portable memory 102 serving as the commutation ticket into the reader 103.

The operation for inserting the portable memory 102 into the reader 103 is originally carried out for the examination of tickets. Thus, the user can unconsciously carry out the operation for obtaining the information. Moreover, the periodical usage of the commutation ticket enables the user to periodically obtain the desirable information.

In the information distribution, however, the convenience of the information obtainment, that is, the accessibility to the information is important. Suppose that a user notices presence of information from visual media, such as an advertisement signboard and a timetable in a station or a bus stop. Easy obtainment of information related to the information shown in the visual media is desirable for the user.

### SUMMARY OF THE INVENTION

Therefore, an object of the present invention is to provide an information distribution system, in which when a user visually knows presence of certain information, the user can easily obtain the information.

Another object of the present invention is to provide an information distribution system that enables easier obtainment of information that explains visual information in detail.

Still another object of the present invention is to provide an information distribution system that enables an easy feedback of a visual advertisement.

In order to achieve an aspect of the present invention, an information distribution system is composed of a plurality of information distribution units, a server, and a mobile terminal. The server selects at least one of the plurality of information distribution units, and transmits first information to the selected information distribution unit. The selected information distribution unit includes a transmitting unit and a display unit. The transmitting unit electrically transmits to the mobile terminal the first information received from the server such that the mobile terminal is able to display the first information. The display unit visually displays second information.

The second information is preferably related to the first information.

The first information may be transmitted from the transmitting unit to the mobile terminal by radio communication.

The first information may be transmitted from the transmitting unit to the mobile terminal by communication through wire.

The information distribution system may be further composed of an electric shielding and the first information may be transmitted from the transmitting unit to the mobile terminal in the electric shielding.

The first information is preferably transmitted from the selected information distribution unit to the server through the Internet.

The mobile terminal preferably includes another display unit displaying the first information.

The selected information distribution unit preferably includes a state indicator visually indicating whether or not the transmitting unit is transmitting the first information.

The mobile terminal preferably includes another state indicator visually indicating whether or not the mobile terminal is receiving the first information.

The second information may include a visual advertisement, and the first information may include what is related to the visual advertisement.

The second information may include a timetable of vehicles and the first information includes third information indicative of the timetable.

The plurality of information distribution units may be installed in a shop and the first information may include fourth information on an item displayed in the shop.

The plurality of information distribution units may be installed in a museum and the first information may include fifth information on an exhibition displayed in the museum.

The plurality of information distribution units may be installed in a zoo and the first information may include sixth information on an exhibition displayed in the zoo.

The mobile terminal preferably sends a request for the first information, and the transmitting unit preferably transmits the first information in response to the request.

The information distribution system is preferably further composed of an information input computer for operation by an information distributor. In this case, the first information is inputted to the information input computer, and the information input computer sends the first information to the server.

The mobile terminal preferably sends a user response to the information input computer.

The first information may include a questionnaire. In this case, the user response preferably includes an answer for the questionnaire.

The user response may include profile data indicative of a profile of a user of the mobile terminal.

The user response may include a user identifier for identifying a user of the mobile terminal.

The information distribution system preferably further includes a profile-managing computer. In this case, the mobile terminal sends another request to the identifier-managing computer, and the profile-managing computer sends profile data indicative of a profile of a user of the mobile terminal in response to the another request.

In order to achieve another aspect of the present invention, an information distribution unit is composed of a transmitting unit electrically transmitting a first information to a mobile station, and a display unit visually displaying second information related to the first information.

In order to achieve still another aspect of the present invention, a method of distributing information is composed of:

selecting at least one information distribution unit from among a plurality of information distribution units;

transmitting first information to the selected information distribution unit;

electrically transmitting to a mobile terminal the first information by the selected information distribution unit; and

visually displaying second information by the selected information distribution unit.

25. The method of distributing information according to claim 24, wherein the second information is related to the first information.

### BRIEF DESCRIPTION OF THE DRAWINGS

FIG. 1 shows a conventional information distribution system;

FIG. 2 shows an embodiment of an information distribution system according to the present invention;

FIG. 3 shows an information distribution unit 41;

FIG. 4 shows a mobile terminal 51;

FIG. 5 shows a menu screen 70;

FIG. 6 shows an incoming screen 80;

FIG. 7 shows detailed information 90, 91; and

FIG. 8 shows an information distribution system in which an identifier management computer 61 is installed.

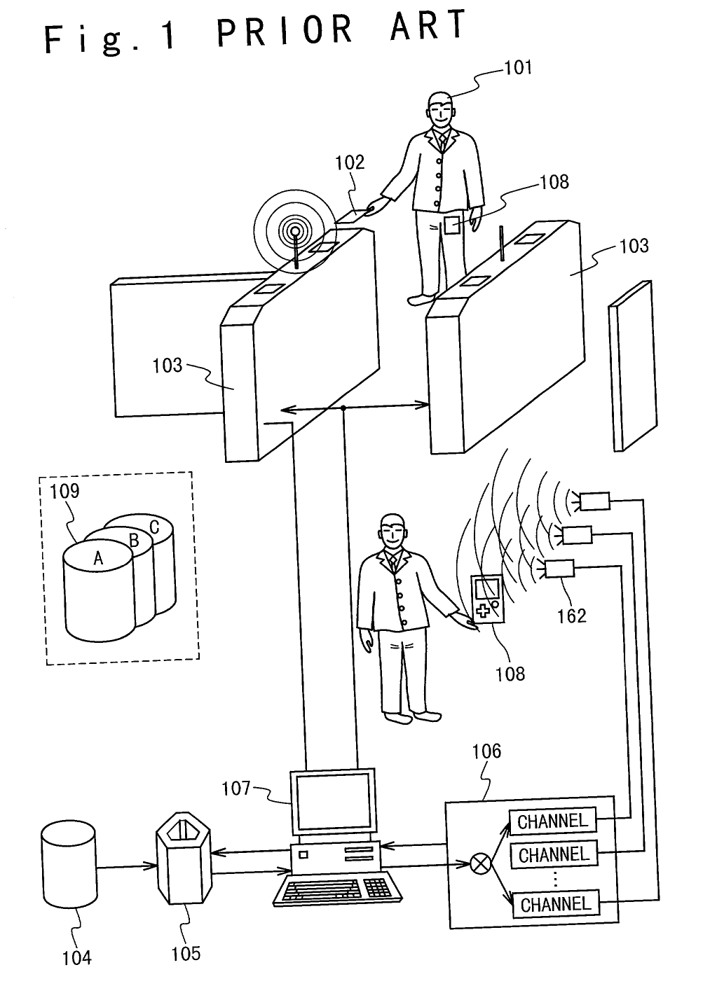

### DESCRIPTION OF THE PREFERRED EMBODIMENTS

An embodiment of an information distribution system according to the present invention will be described below with reference to the attached drawings.

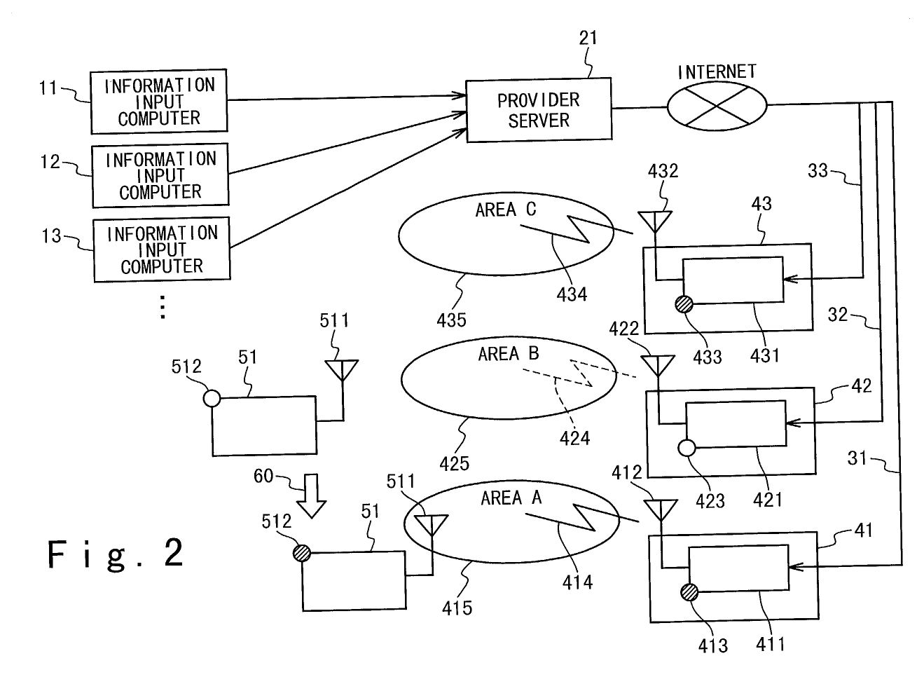

FIG. 2 shows an embodiment of an information distribution system according to the present invention. The information distribution system is used as an advertisement distribution system. The information distribution system is composed of a provider server 21 and information distribution units 41, 42 and 43. The information distribution units 41, 42 and 43 are managed by the provider server 21. The information distribution units 41, 42 and 43 are respectively connected through the Internet to the provider server 21. The links 31, 32 and 33 may be other wired links or radio links.

The provider server 21 is connected through the Internet to information input computers 11, 12 and 13. The information input computers 11, 12, and 13 are provided for the operation by information distributors. The information input computers 11 to 13 send to the provider server 21 advertisement data which the information distributors desires to distribute. The provider server 21 receives the advertisement data and processes into a format suitable for a transmission/reception. The provider server 21 transmits the advertisement data through the Internet to the information distribution unit 41, 42 and 43. Hereafter, the routes through which the provider server 21 transmits the advertisement data to the information distribution units 41 to 43 are referred to the routes 31, 32 and 33, respectively.

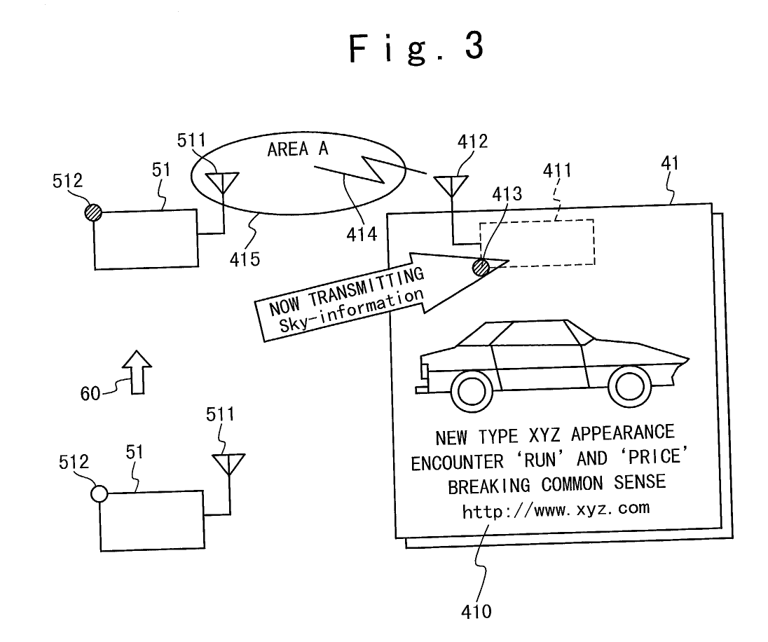

FIG. 3 shows the information distribution unit 41. The information distribution unit 41 contains a display unit 410, a transmitter 411, an antenna 412 and a transmission indication lamp 413.

The display unit 410 is an eye catcher for displaying visual information. In this embodiment, the display unit 410 is an advertisement signboard visually displaying an advertisement. The display unit 410 may be an advertisement display, a shop or a show window at a shop.

A transmitter 411 electrically transmits the advertisement data received from the provider server 21. In detail, the transmitter 411 receives the advertisement data from the provider server 21 and transmits from the antenna 412 on an electrical wave 414. The electrical wave 414 emitted by the transmitter 411 can be received within an area 415.

The transmission indication lamp 413 indicates whether or not the electrical wave 414 is emitted. The lighting of the antenna 412 implies that the electrical wave 414 is being transmitted.

The information distribution unit 42, 43 shown in FIG. 2 have the same configuration as the information distribution unit 41. The information distribution unit 42 contains a transmitter 421, an antenna 422 and a transmission indication lamp 423. The information distribution unit 43 contains a transmitter 431, an antenna 432 and a transmission indication lamp 433. An electrical wave 424 emitted by the transmitter 421 and an electrical wave 434 emitted by the transmitter 431 can be received within areas 425, 426, respectively.

It is desirable that the reachable distances of the electrical waves 414, 424 and 434 are limited to a degree that the areas 424, 425 and 426 do not overlap with each other. The information distribution units 42 and 43 have the identical functions to the information distribution unit 41. Detailed explanations on the information distribution units 42 and 43 are omitted.

A mobile terminal 51 receives the electrical wave 414 from the information distribution unit 41 when located within the area 415. Similarly, the mobile terminal 51, when located within the area 425, receives the electrical wave 424 from the information distribution unit 42. Moreover, the mobile terminal 51, when located within the area 435, receives the electrical wave 434 from the information distribution unit 43.

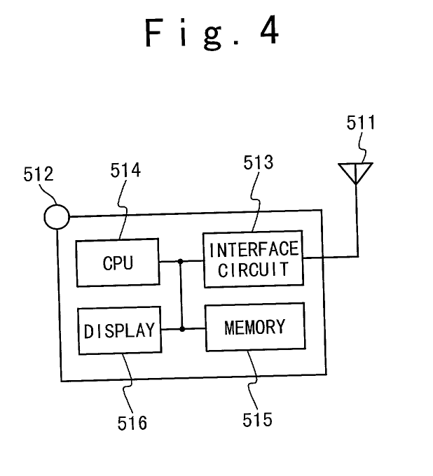

As shown in FIG. 4, the mobile terminal 51 includes an antenna 511, a reception indication lamp 512, an interface circuit 513, a CPU 514, a memory 515 and a display 516. The antenna 511 is used to receive the electrical waves 414, 424 and 434. The reception indication lamp 512 indicates whether or not the mobile terminal 51 is located at a position at which the electrical wave 414, 424 or 434 can be received. When the mobile terminal 51 is located at the position where the mobile terminal 51 can receive any of the electrical waves 414, 424 and 434, the reception indication lamp 512 is put on.

The interface circuit 513 receives and demodulates the electrical waves 414, 424 and 423.

The CPU 514 controls the entire mobile terminal 51. The CPU 514 fetches the advertisement data from the electrical waves 414, 424 and 423 and stores the advertisement data in the memory 515. Moreover, the CPU 514 controls the reception indication lamp 512 so as to turn on and off it.

The memory 515 stores the advertisement data and the other data treated by the mobile terminal 51.

The display 516 displays the various information including the advertisement data stored in the memory 515.

A portable telephone, a PHS and a portable computer may be used as the mobile terminal 51.

The mobile terminal 51 preferably has a function to be connected to the Internet provider. In this case, the mobile terminal 51 may transfer to the Internet provider the received advertisement data, and the Internet provider may store in a local directory, that is, a store area provided for the user of the mobile terminal 51. In this case, the obtained advertisement data can be referred without being continuously stored in the mobile terminal 51.

A method of using the information distribution system is described in the following. An information distributor concludes a contract with a manager of the information distribution system, and obtains a right to use the information distribution units 41, 42 and 43. Here, let us suppose that an information distributor A managing an information input computer 11 obtains a right to use the information distribution unit 41, an information distributor B managing an information input computer 12 obtains a right to use the information distribution unit 42, and an information distributor C managing an information input computer 13 obtains a right to use the information distribution unit 43.

The information distributor A displays an advertisement in the display unit 410 of the information distribution unit 41. Moreover, the information distributor A inputs an advertisement data A to the information input computer 11, and transmits to the provider server 21. At this time, the advertisement data A is preferably related to the advertisement displayed in the display unit 410, that is, advertisement data A preferably has the content explaining the advertisement in detail.

Similarly, an information distributor B inputs an advertisement data B to the information input computer 12, and transmits to the provider server 21. The advertisement data B is preferably related to the advertisement displayed in the information distribution unit 42. Moreover, an information distributor C inputs an advertisement data C to the information input computer 13, and transmits to the provider server 21. The advertisement data C is preferably related to the advertisement displayed in the information distribution unit 42.

The provider server 21 selects one or more of the information distribution unit 41, 42 and 43 as a selected information distribution unit(s) and transmits the advertisement data to the selected information distribution unit(s) for which each of the information distributors has the usage right. That is, the provider server 21 transmits the advertisement data A to the information distribution unit 41, transmits the advertisement data B to the information distribution unit 42, and transmits the advertisement data C to the information distribution unit 43, respectively.

The information distribution unit 41 transmits the advertisement data A on the electrical wave 414. The information distribution unit 42 transmits the advertisement data B on the electrical wave 424. And, the information distribution unit 43 transmits the advertisement data C on the electrical wave 434.

The mobile terminal 51 receives the advertisement data transmitted by the information distribution unit 41, 42 and 43. The advertisement data are received as follows.

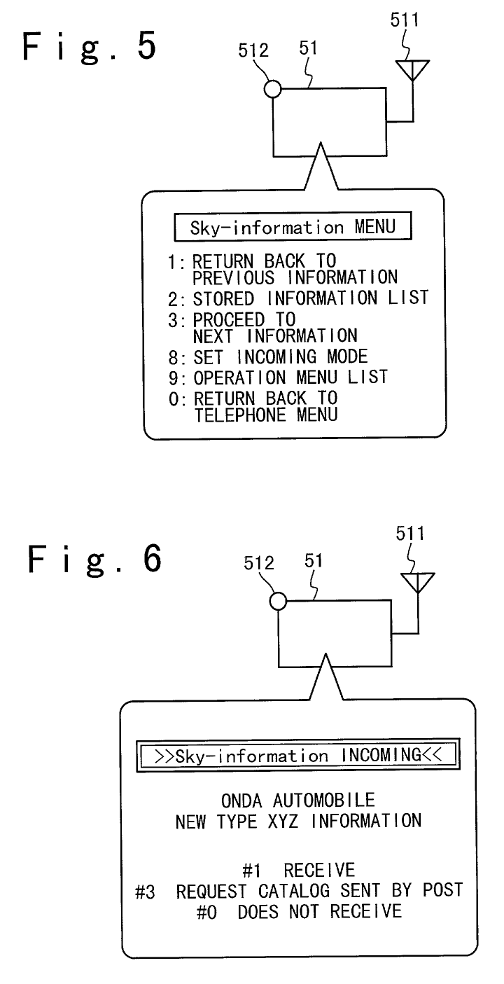

If the mobile terminal 51 is not located within any of the areas 415, 425 and 435, the reception indication lamp 512 of the mobile terminal 51 is put off by the control of the CPU 514, as shown in FIG. 2. Moreover, the CPU 514 displays a menu screen 70 shown in FIG. 5 on the display 516.

Let us suppose that a possessor of the mobile terminal 51 views the information distribution unit 41. The possessor obtains the advertisement displayed in the information distribution unit 41 as visual information. This advertisement has the content desired by the information distributor A. The possessor notices that the information with regard to the advertisement, namely, the advertisement data A is transmitted through the electrical wave via the antenna 412 of the information distribution unit 41. If the possessor is interested in the advertisement, the possessor approaches the information distribution unit 41, and moves up to the area 415, at which the electrical wave 414 arrives. The mobile terminal 51 together with the possessor moves up to the area 415. When the mobile terminal 51 goes into the area 415 as shown by an arrow 60, the CPU 514 of the mobile terminal 51 puts on the reception indication lamp 512. Moreover, the CPU 514 displays an incoming screen 80 shown in FIG. 6 on the display 516.

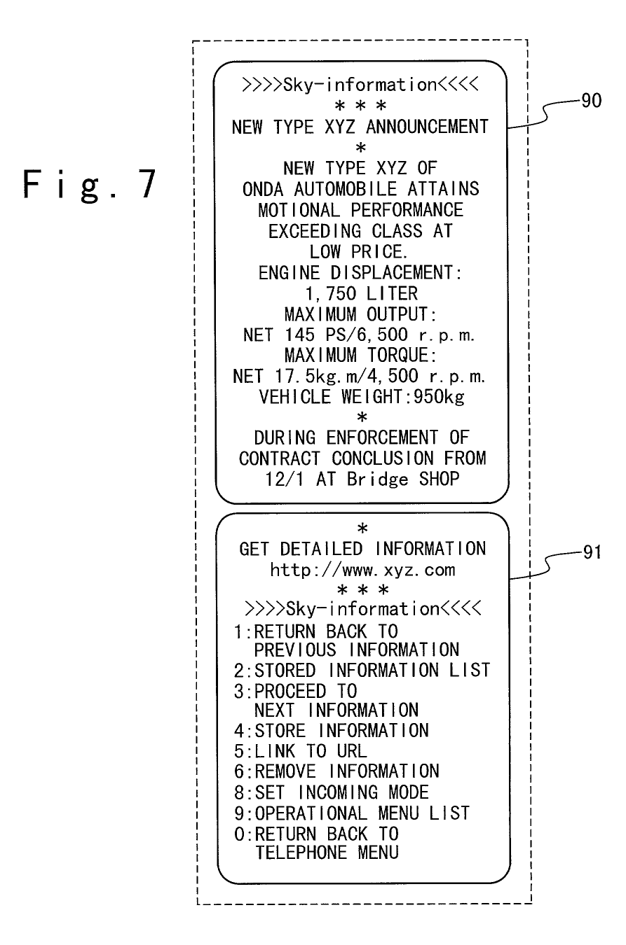

The possessor can select a command #1 (reception) by operating the mobile terminal 51 if desiring the reception of the advertisement data A. The CPU 514 of the mobile terminal 51 transmits the command #1 if the command #1 is selected. The information distribution unit 41 transmits the advertisement data A in response to the command #1. The mobile terminal 51 receives the advertisement data A. The received advertisement data A is stored in the memory 515. The CPU 514 displays the detailed information 90, 91, which explain in detail the advertisement displayed in the information distribution unit 41, on the display 516, in accordance with the received advertisement data A, as shown in FIG. 7.

The possessor can reject the reception of the advertisement data A by operating the mobile terminal 51 if the possessor does not desire the reception of the advertisement data A.

Also, if the possessor views the advertisement displayed in the information distribution unit 41 and desires that a catalog with regard to the advertisement is sent by post, the possessor can select a command #3 (requesting that a catalog is sent by post) as shown in FIG. 6. When the command #3 is selected, the CPU 514 of the mobile terminal 51 transmits the command #3 together with a profile information indicative of an address and a name of the possessor. The transmitted command #3 and profile information are fed back to the information input computer 11. The advertisement distributor A can receive the command #3 and the profile information through the information input computer 11 and send the catalog by post.

In view of security, the profile information preferably includes an ID number and an encryption number for identifying the possessor and does not include the address and the name of the possessor. In this case, the address and the name of the possessor are correlated to the ID number and the encryption number and accumulated in the information input computer 11. The address and the name of the possessor are specified on the basis of the ID number and the encryption number, and the catalog is sent by post by using the address and the name.

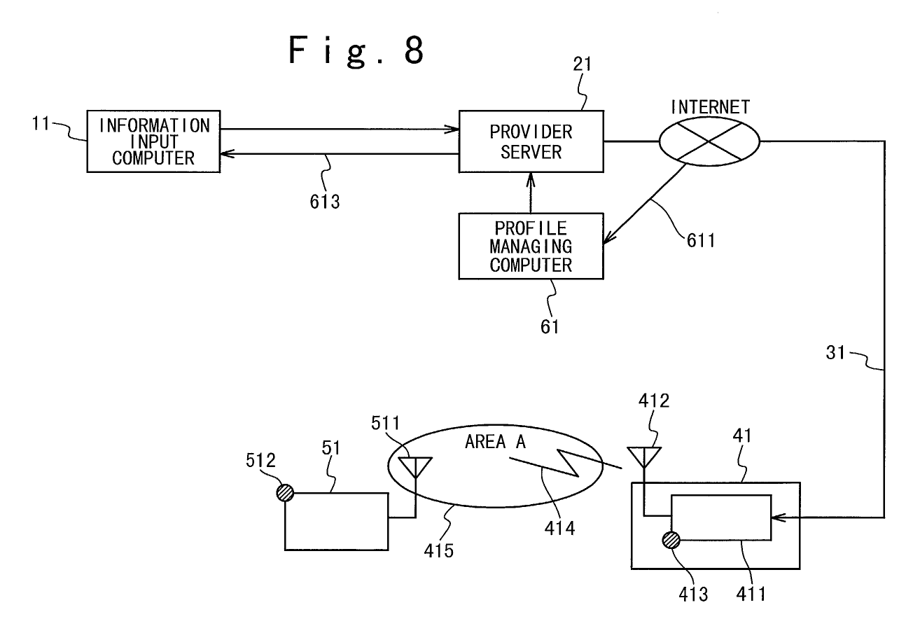

In order to manage the profile information used when the catalog is sent by post, the information distribution system includes a profile-managing computer 61, as shown in FIG. 8. The profile-managing computer 61 is used to operate a profile management company. The address and the name of the possessor are correlated to the ID number and the encryption number and accumulated in the profile-managing computer 61. When the catalog is required to be sent by post by the possessor, the mobile terminal 51 transmits a request 611 for sending the catalog by post, the ID number and the encryption number to the profile managing computer 61. The profile-managing computer 61 retrieves the address and the name of the possessor, on the basis of the ID number and the encryption number. Then the profile-managing computer 61 transmits a catalog request 613 for requesting the catalog together with the address and the name of the possessor through the provider server 21 to the information input computer 11. The information distributor A managing the information input computer 11 sends the catalog by post, in accordance with the catalog request 613 in which the address and the name of the possessor are noted.

The advertisement data B, C distributed by the information distributors B, C are similarly received and processed by the mobile terminal 51.

The advertisement data A, B, and C may include a questionnaire. In this case, the feedback from the mobile terminal 51 to the information input computer 11, 12 and 13 may include an answer of the questionnaire. If the information distribution units 41, 42 and 43 are installed at a place where people use for waiting and the questionnaire is sent through the information distribution units 41, 42 and 43, it is easy to obtain answers for the questionnaire.

The above described information distribution system provides users with further information related to visual information with superior accessibility. That is, the users can easily obtains further information related to visual information after the users find the visual information.

The information distribution system also has merit that the information distributors can easily update the advertisement data. The advertisement data is the electronic data, and this facilitates the update of information. In particular, if a distributed information consists of a character information, a simple picture or a BGM, it is also possible to update the information in a manner of updating a data of a home page by a personal computer or a word processor.

In another embodiment of the information distribution system according to the present invention, the information distribution unit 41, 42 and 43 are installed in a shop. In this embodiment, the information visually transmitted by the information distribution unit 41, 42 and 43 is the items exhibited in the shop. At this time, the information distribution units 41 to 43 transmit data related to the exhibited items through the electrical wave.

In still another embodiment of the information distribution system according to the present invention, the information distribution units 41, 42 and 43 are installed in a museum or a zoo. In this case, the information distribution units 41, 42 and 43 respectively contain exhibitions for visually sending information and transmitters 411, 421 and a transmitter 431. If the possessor of the mobile terminal 51 visits the museum or the zoo, the transmitters 411, 421 and 431 transmit an exhibition sample data with regard to the exhibitions to the mobile terminal 51. Thus, the mobile terminal 51 selectively receives the data for explaining the exhibitions in further detail. The exhibition data may be reproduced as voice by a voice-synthesizing device (not shown) installed in the mobile terminal 51.

In still another embodiment of the information distribution system according to the present invention, the information distribution units 41, 42 and 43 are installed in stations. The information distribution units 41, 42 and 43 visually display a timetable of trains. At the same time, the information distribution units 41, 42, and 43 transmit a timetable data indicative of the timetable. The mobile terminal 51 receives the timetable data from the information distribution units 41, 42, and 43 and displays it.

In this case, the mobile terminal 51 can store therein the timetable data indicative of the timetable. The mobile terminal 51 displays the timetable data in response to the operation performed on the mobile terminal 51.

Also, the timetable data can be sent to a provider of the Internet and stored in a local directory provided for the possessor in accordance with the desire of the possessor of the mobile terminal 51. In this case, a timetable of a station that is not frequently required is stored in the local directory. The timetable data can be called and referred as necessary. This promotes convenience for the possessor of the mobile terminal 51.

In the above-mentioned embodiments, the communication is wirelessly carried out between the information distribution unit 41 to 43 and the mobile terminal 51. The communication may be done through wire. In this case, connectors are provided between the information distribution units 41, 42 and 43 and the mobile terminal 51, and the communication is carried out through the connectors. If the information distribution units for transmitting the advertisement data are crowded or the condition of the electrical wave is poor, the advertisement data is transmitted through the connectors.

Also, electrically shielded boxes (not shown) may be provided in the information distribution unit 41, 42 and 43. In this case, the advertisement data is transmitted from the information distribution unit 41, 42 and 43 and the mobile terminal 51 when the mobile terminal 51 is located within the box. Accordingly, interference is reduced to improve the reliability of the transmission/reception.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. An information distribution system comprising:
a plurality of information distribution units;
a server selecting at least one information distribution unit from among said plurality of information distribution units, and transmitting first information to said selected information distribution unit; and
a mobile terminal, and
wherein said selected information distribution unit includes:
a transmitting unit electrically transmitting to said mobile terminal said first information received from said server such that said mobile terminal is able to display said first information, and
a display unit visually displaying second information.

2. The information distribution system according to claim 1, wherein said second information is related to said first information.

3. The information distribution system according to claim 1, wherein said first information is transmitted from said transmitting unit to said mobile terminal by radio communication.

4. The information distribution system according to claim 1, wherein said first information is transmitted from said transmitting unit to said mobile terminal by communication through wire.

5. The information distribution system according to claim 1, further comprising an electric shielding and said first information is transmitted from said transmitting unit to said mobile terminal in said electric shielding.

6. The information distribution system according to claim 1, wherein said first information is transmitted from said selected information distribution unit to said server through the Internet.

7. The information distribution system according to claim 1, wherein said mobile terminal includes another display unit displaying said first information.

8. The information distribution system according to claim 1, wherein said selected information distribution unit further includes a state indicator visually indicating whether or not said transmitting unit is transmitting said first information.

9. The information distribution system according to claim 1, wherein said mobile terminal includes another state indicator visually indicating whether or not said mobile terminal is receiving said first information.

10. The information distribution system according to claim 1, wherein said second information includes a visual advertisement, and
said first information includes what is related to said visual advertisement.

11. The information distribution system according to claim 1, wherein said second information includes a timetable of vehicles and said first information includes third information indicative of said timetable.

12. The information distribution system according to claim 1, wherein said plurality of information distribution units are installed in a shop and said first information includes fourth information on an item displayed in said shop.

13. The information distribution system according to claim 1, wherein said plurality of information distribution units are installed in a museum and said first information includes fifth information on an exhibition displayed in said museum.

14. The information distribution system according to claim 1, wherein said plurality of information distribution units are installed in a zoo and said first information includes sixth information on an exhibition displayed in said zoo.

15. The information distribution system according to claim 1, wherein said mobile terminal sends a request for said first information, and said transmitting unit transmits said first information in response to said request.

16. The information distribution system according to claim 1, further comprising an information input computer for operation by an information distributor, wherein said first information is inputted to said information input computer, and
said information input computer sends said first information to said server.

17. The information distribution system according to claim 16, wherein said mobile terminal sends a user response to said information input computer.

18. The information distribution system according to claim 17, wherein said first information includes a questionnaire and said user response includes an answer for said questionnaire.

19. The information distribution system according to claim 17, wherein said user response includes profile data indicative of a profile of a user of said mobile terminal.

20. The information distribution system according to claim 17, wherein said user response includes a user identifier for identifying a user of said mobile terminal.

21. The information distribution system according to claim 16, further includes a profile-managing computer, wherein said mobile terminal sends another request to said identifier-managing computer, and said profile-managing computer sends profile data indicative of a profile of a user of said mobile terminal in response to said another request.

22. An information distribution unit comprising:
a transmitting unit electrically transmitting a first information to a mobile station; and
a display unit visually displaying second information related to said first information.

23. The information distribution unit according to claim 22, wherein said transmitting unit transmitting said first information to said mobile station by radio communication.

24. A method of distributing information comprising:
selecting at least one information distribution unit from among a plurality of information distribution units;
transmitting first information to said selected information distribution unit;
electrically transmitting to a mobile terminal said first information by said selected information distribution unit; and
visually displaying second information by said selected information distribution unit.

25. The method of distributing information according to claim 24, wherein said second information is related to said first information.
